(19) United States
(12) Patent Application Publication
(10) Pub. No.: US 2003/0203741 A1
(43) Pub. Date: Oct. 30, 2003

(54) Autonomous distributed wireless network system, method of autonomous distributed wireless network communication and wireless terminal apparatus

(75) Inventors: Ryoko Matsuo, Tokyo (JP); Syuichi Sekine, Kanagawa-Ken (JP); Mutsumu Serizawa, Tokyo (JP); Hiroki Shoki, Kanagawa-Ken (JP); Hiroshi Tsurumi, Kanagawa-Ken (JP); Shuichi Obayashi, (US); Tomoko Adachi, Kanagawa-Ken (JP); Kiyoshi Toshimitsu, Kanagawa-Ken (JP); Tsuguhide Aoki, Kanagawa-Ken (JP); Ren Sakata, Kanagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/423,946

(22) Filed: Apr. 28, 2003

(30) Foreign Application Priority Data
Apr. 26, 2002 (JP) 2002-127282

(51) Int. Cl. H04B 7/00; H04Q 7/20

(52) U.S. Cl. 455/519; 455/518

(57) ABSTRACT

An object of the present invention is to prevent congestion of networks and to effectively use a plurality of autonomous distributed wireless networks.

An autonomous distributed wireless network system in which a plurality of wireless terminals communicate with each other, comprising: a plurality of autonomous distributed wireless networks each having a different communication form, and being constituted of a plurality of wireless terminals, wherein each of said plurality of wireless terminals has a network selector which allocates said plurality of autonomous distributed wireless networks to communicate different categories of information with different autonomous distributed wireless networks.

### CROSS REFERENCE TO RELATED APPLICATIONS

This application claims benefit of priority under 35USC §119 to Japanese Patent Application No. 2002-127282, filed on Apr. 26, 2002, the entire contents of which are incorporated by reference herein.

### BACKGROUND OF THE INVENTION

1. Field of the Invention

The present invention relates to an autonomous distributed wireless network system, a method of autonomous distributed wireless network communication, and a wireless terminal having an autonomous distributed wireless network which communicates with a plurality of wireless terminals, without relaying a base station.

2. Related Art

A network constituted of only terminals (such as a PC, a PDA and a portable phone), which does not need access points, like a wireless LAN, is called an autonomous distributed wireless network or an ad-hoc network.

Such an ad-hoc network has an advantage in which it is possible to temporarily constitute an LAN within a constant range without performing central control such as a cellular network, or to put it another way, without connecting to a central control network.

In the near future, it is predicted that the amount of information transmitted and received between the wireless terminals increases, and the information with different communication properties such as communication quality and transmission speed will be transmitted on the ad-hoc network. In this case, with only a single ad-hoc network, the throughput of the entire system lowers, and congestion of the network may occur.

Because of this, a network form that the wireless terminal belonging to a single ad-hoc network can also communicate with the central control network has been proposed.

FIG. 18 is a diagram showing an example of such a communication system. The wireless terminals 1-5 of FIG. 18 are capable of connecting to a plurality of network systems. The wireless terminals 1-4 belong to only an ad-hoc network 10, and the wireless terminal 5 belongs to both of the ad-hoc network and the central control network C.

Although the wireless terminals 1-4 functionally can be connected to the multisystem, they belong to only the ad-hoc network 10. Because of this, they cannot communicate with a plurality of wireless systems.

Furthermore, there is a higher possibility in which information with different communication properties such as the amount of information, the communication quality and the transmission speed increases. Because of this, it may be impossible to normally receive all the information with only one wireless terminal.

Moreover, the conventional wireless terminal performs a diversity by the antenna of a wireless terminal dedicated to reception or a mobile station, or tries to exactly receive larger amount of information by constituting a smart antenna. However, a plurality of antennas become necessary, and each antenna has to be disposed separate from a desirable distance to realize non-directivity and non-correlation. Because of this, it is difficult to realize non-directivity and non-correlation in the wireless terminal which advances downsizing.

When various information of which properties such as the amount of information and the transmission speed are remarkably different is communicated by only a single ad-hoc network, communication quality lowers.

On the other hand, if the wireless terminal which are capable of connecting the multisystem always belongs to a plurality of ad-hoc network, there is a problem in which power consumption increases.

### SUMMARY OF THE INVENTION

An object of the present invention is to provide an autonomous distributed wireless network system, a method of autonomous distributed wireless network communication and a wireless terminal apparatus capable which can use effectively a plurality of autonomous distributed wireless networks.

In order to achieve the foregoing object, an autonomous distributed wireless network system in which a plurality of wireless terminals communicate with each other, comprising:

a plurality of autonomous distributed wireless networks each having a different communication form, and being constituted of a plurality of wireless terminals,

wherein each of said plurality of wireless terminals has a network selector which allocates said plurality of autonomous distributed wireless networks to communicate different categories of information with different autonomous distributed wireless networks.

### BRIEF DESCRIPTION OF THE DRAWINGS

FIG. 1 is a diagram showing a network form of a first embodiment of an ad-hoc network system according to the present invention.

FIG. 2 is a diagram showing the other example of an ad-hoc network system which selectively uses for communication qualities.

FIG. 3 is a block diagram showing internal configuration of a wireless terminal in a multisystem of FIGS. 1 and 2.

FIG. 4 is a sequence diagram showing processing procedure performed by each of wireless terminals when the ad-hoc network is formed.

FIG. 5 is a sequence diagram showing processing procedure in the case of selectively using a plurality of ad-hoc networks according to communication qualities.

FIG. 6 is a diagram showing a network form of a second embodiment of an ad-hoc network system according to the present invention.

FIG. 7 is a sequence diagram showing processing procedure of a second embodiment of an ad-hoc network system according to the present invention.

FIG. 8 is a diagram showing a network form of a third embodiment of an ad-hoc network system according to the present invention.

FIG. 9 is a sequence diagram showing processing procedure of an ad-hoc network system according to the present invention.

FIG. 10 is a diagram showing a network form of a fourth embodiment of an ad-hoc network system according to the present invention.

FIG. 11 is a diagram showing an example of receiving data from a base station while a plurality of wireless terminals cooperate.

FIG. 12 is a diagram showing the other example in which a plurality of wireless terminals cooperate to receive data from a base station.

FIG. 13 is a diagram showing internal configuration of a wireless terminal when a plurality of wireless terminals cooperatively receive data from a base station.

FIG. 14 is a sequence diagram showing processing procedure in the case where fragments of information cooperatively received by wireless terminals are combined and distributed.

FIG. 15 is a sequence diagram showing processing procedure in the case where a plurality of ad-hoc network are selectively used for interference tolerance.

FIG. 16 is a diagram showing a network form of a fifth embodiment of an ad-hoc network system according to the present invention.

FIG. 17 is a sequence diagram showing processing procedure of a fifth embodiment of an ad-hoc network system according to the present invention.

FIG. 18 is a diagram showing one example of a system in which a wireless terminal belonging to an ad-hoc network communicates with a central control network.

### DESCRIPTION OF THE PREFERRED EMBODIMENTS

Hereinafter, an autonomous distributed wireless network system, a method of autonomous distributed wireless network communication and a wireless terminal will be more specifically described with reference to drawings.

(First Embodiment)

One of features of a first embodiment lies in that a plurality of autonomous distributed wireless network (hereinafter, called an ad-hoc network) are selectively used for communication qualities.

FIG. 1 is a diagram showing a network form of the first embodiment of an ad-hoc network system. The system of FIG. 1 has two ad-hoc network 101 and 102 with different communication speeds in which one is a short-distance wireless network using a frequency hopping system known as Bluetooth, and another is a wireless LAN using a direct spread system represented by IEEE802.11. The wireless terminals in the ad-hoc network 101 can communicate at higher speed than the wireless terminals in the ad-hoc network 102. Since a plurality of systems with different speeds exist in the wireless LAN, one of wireless LANs with different speeds maybe the ad-hoc network 101, and another maybe the ad-hoc network 102.

A plurality of wireless terminals 1-16 belong to the ad-hoc networks 101 and 102. The wireless terminals 11-16 of FIG. 1 are capable of connecting to the multisystem, and can communicate with the ad-hoc networks 101 and 102.

For example, in the case of communicating with the wireless terminals 14, 15 and 16, it is supposed that a distance between the terminals is short, the received signal strength indication is large (the influence of the fading is small), a state of a communication path is good, and a communication quality is good. Because of this, communication is performed by using the ad-hoc network with higher communication speed.

On the other hand, in the case of communicating with the wireless terminals 13 and 14, or the wireless terminals 11 and 12 of FIG. 1, it is supposed that the state of the communication path is not good, and the communication quality is not good. Because of this, communication is performed by using the ad-hoc network 102 at lower communication speed.

The ad-hoc networks 101 and 102 may transmit and receive the same information or informations different from each other.

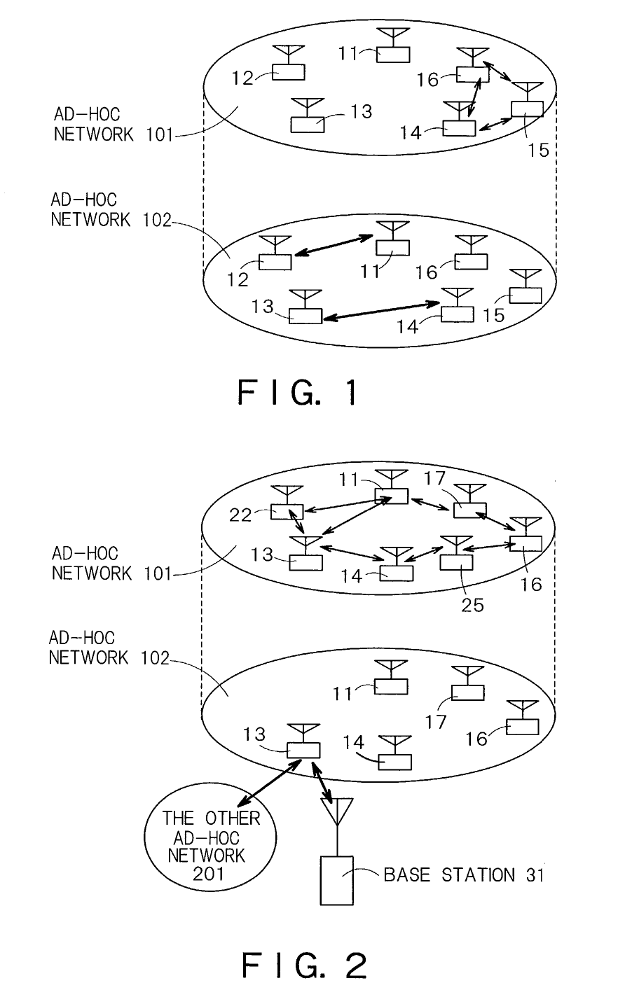

FIG. 2 is a diagram showing the other example of the ad-hoc network system which selectively uses a plurality of ad-hoc networks 101 and 102 according to communication qualities. The system of FIG. 2 has the ad-hoc network 101 used in the case of communicating with the wireless terminals in the same ad-hoc network and the ad-hoc network 102 capable of communicating with the base station 31 of a central control network such as a cellular network and the wireless terminals in the other ad-hoc network 201.

In the ad-hoc networks 101 and 102 of FIG. 2, specifications such as modulation systems, and multi-valued numbers and frequencies of the same modulation system are different from each other. The wireless terminals in the ad-hoc network 102 can communicate at higher speed than the wireless terminals in the ad-hoc network 101.

Wireless terminals 11, 13, 14, 16 and 17 which are capable of connecting to the multisystem and the wireless terminals 22 and 25 which are not capable of connecting to the multisystem exist in the ad-hoc network system of FIG. 2.

The wireless terminal 13 uses the ad-hoc network 102 capable of communicating at high-speed when communicating with a base station 31 and the wireless terminals in the other ad-hoc network 201. Furthermore, when the information obtained by communication with the base station 31 and the other ad-hoc network 201 has to be transmitted to the wireless terminals 22 and 25 which are not capable of connecting to the multisystem, the communication at lower speed is performed by using the ad-hoc network 101.

Thus, the wireless terminals 22 and 25 which are not capable of connecting to the multisystem can obtain the information from the base station 31 and the other ad-hoc network 201 through the wireless terminal 11 and so on in the multisystem.

On the other hand, although it is possible to communicate with the wireless terminals in the same ad-hoc network at high speed, when the state of the communication path between the base station 31 and the other ad-hoc network 201 is not good, higher speed communication may be performed by using the ad-hoc network 101, and lower speed communication may be performed by using the ad-hoc network 102.

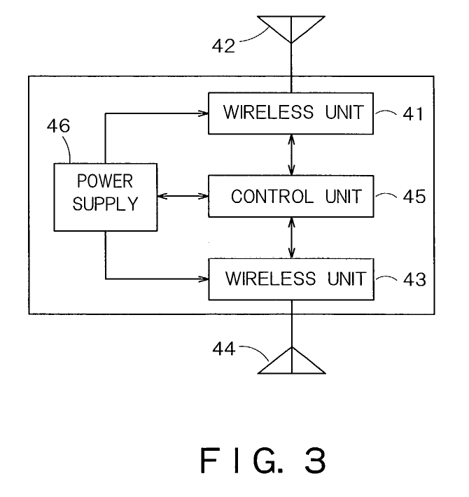

FIG. 3 is a block diagram showing internal configuration of the wireless terminals in the multisystem of FIG. 1 and FIG. 2. The wireless terminal of FIG. 3 has a wireless unit 41 and an antenna 42 for connecting to the ad-hoc network 101, a wireless unit 43 and an antenna 44 for connecting to the ad-hoc network 102, a control unit for controlling the entire terminal, and a power supply for supplying power to each unit.

The control unit instructs the wireless units 41 and 43 to measure the reception electric field strength. After receiving this instruction, the wireless units 41 and 43 measure the electric field strength of the reception signal received via the corresponding ad-hoc networks 101 and 102, and transmit the measured result to the control unit 45. The control unit 45 selects the wireless unit for communicating based on the electric field strength measured by the wireless units 41 and 43.

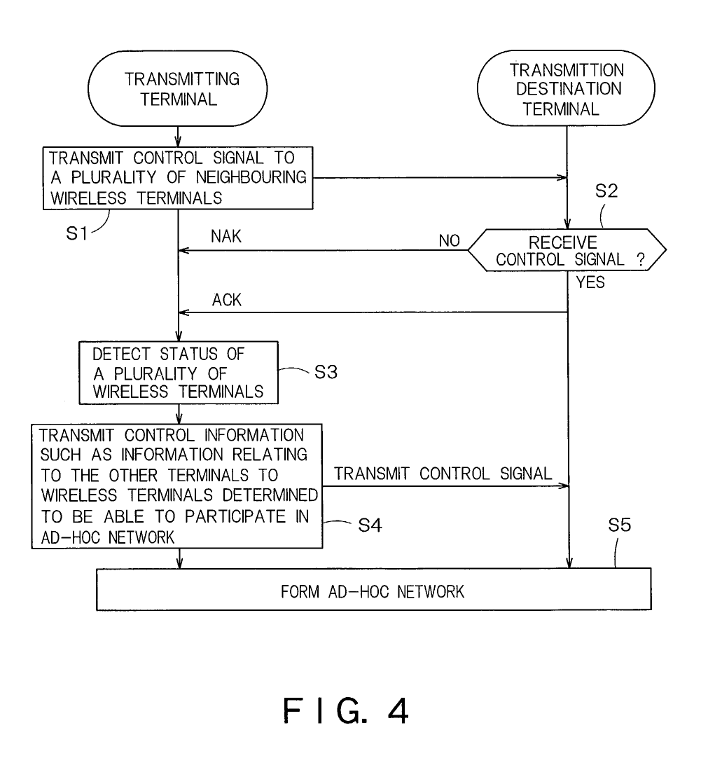

FIG. 4 is a sequence diagram performed by the wireless terminals at the time of forming the ad-hoc network. First of all, the wireless terminal (hereinafter, called a transmitting terminal) which wants to form the ad-hoc network transmits a control signal to a plurality of neighboring wireless terminals (step S1). The plurality of neighboring wireless terminals determine whether or not the control signal has been received (step S2). If the control signal is not received, an NACK signal is transmitted to the transmitting terminal. If the control signal is received, an ACK signal is transmitted to the transmitting terminal.

Subsequently, the transmitting terminal detects the state of a plurality of wireless terminals based on the NACK signal and the ACK signal transmitted from a plurality of neighboring wireless terminals (step S3). More specifically, it is determined that the transmitting terminal which returned the ACK signal within the prescribed time period can be participated in the ad-hoc network. The control information such as information relating to the other wireless terminals which participate in this network is transmitted to the wireless terminal that it has been determined to be able to participate in the ad-hoc network (step S4). Therefore, the ad-hoc network is formed (step S5).

FIG. 4 shows processing procedure in the case of forming one ad-hoc network. The same processings as those of FIG. 4 are performed for each network in parallel or in order.

When the ad-hoc network transmits and receives the signal to/from the base station, the base station may transmit the control information in step S4 of FIG. 4, or if a representative wireless terminal exist in the ad-hoc network, the representative wireless terminal may transmit the control information.

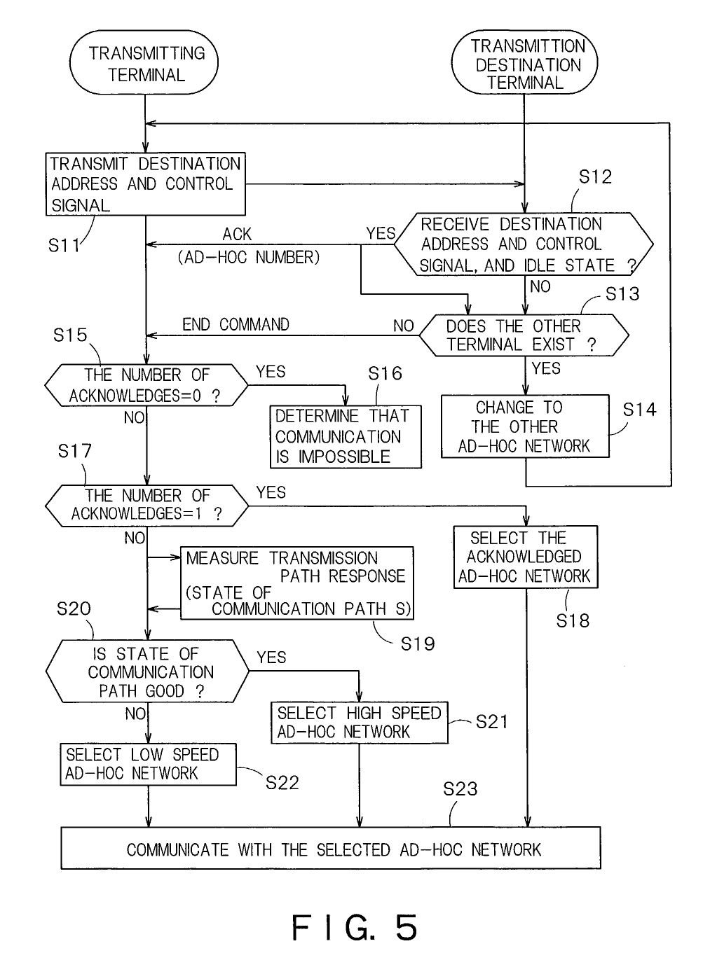

FIG. 5 is a sequence diagram showing processing procedure in the case where a plurality of ad-hoc networks 101 and 102 are selectively used for communication qualities. First of all, the transmitting terminal (or a wireless terminal which receives the signal from the other network or the base station, and distributes the signal) transmits the destination address and the control signal to peripheral wireless terminals (hereinafter, called a transmission destination terminal) (step S11).

The transmission destination terminals determine whether or not the destination address and the control signal have been received, and whether or not a current state is an idle state (step S12). Here, the idle state shows the state in which the transmission destination terminals do not transmit and receive information by using the same ad-hoc network.

If the destination address and the control signal are received, and the current state is the idle state, the ACK signal is transmitted to the transmission destination terminal.

If the ACK signal is transmitted, the destination address and the control signal have not been received within a prescribed time period, or the current state is not the idle state, it is determined whether or not the other ad-hoc network exists (step S13). If the other ad-hoc network does not exist, an END command is transmitted to the transmitting terminal. If the other ad-hoc network exists, changing to the other ad-hoc network is performed (step S14), and the processings on and after step S11 are performed.

The transmitting terminal determines whether or not the number of the wireless terminals which returned the ACK signal is zero (step S15). If zero, it is determined that communication is impossibility (step S16).

When determined that the number of the wireless terminals which returned the ACK signal is not zero, it is determined whether or not the number is “1” (step S17). If “1”, the communication is begun by using the ad-hoc network which returned the ACK signal (step S18).

When determined that the number of the wireless terminals which returned the ACK signal is not “1”, a response of transmission path between the wireless terminals which returned the ACK signal is measured to detect the state S of the communication path (step S19).

Subsequently, it is determined for each wireless terminal whether or not the state S of the communication path is good (step S20). If good, the high-speed ad-hoc network is selected (step S21). If not good, the low-speed ad-hoc network is selected (step S22). The communication is begun by using the selected ad-hoc network (step S23).

In the sequence diagram of FIG. 5, when a plurality of transmission destination terminals exist, the number of the ACK signals of all the transmission destination terminals maybe added, or the number of the ACK signals may be counted for each of transmission destination terminals. When the number of the ACK signals of all the transmission destination terminals is added, the processings of the transmitting terminal are simplified. If at least one of the transmission destination terminals does not return the ACK signal, it is determined that the communication is impossible. If the state of the communication path of at least one of the transmission destination terminals is bad, the low-speed ad-hoc network is used. On the other hand, when the number of the ACK signals is separately counted for each of the transmission destination terminals, although the processings of the transmission destination terminal become heavy, it is possible to perform the transmission suitable for the state of the transmission destination terminals.

Thus, according to the first embodiment, the ad-hoc network is selected by judging the state of the communication path based on the information such as the reception signal strength from the wireless terminal or the base station of the communication destination. Because of this, it is possible to select the ad-hoc network in which the communication quality and the transmission speed are optimum.

Furthermore, each of the wireless terminals belonging to the ad-hoc network may measure the reception signal strength of the other wireless terminal being the communication destination, or may detect the state of communication path by estimating the response of the transmission path.

(Second Embodiment)

One of features of a second embodiment lies in that a plurality of ad-hoc networks are selectively used for power consumption.

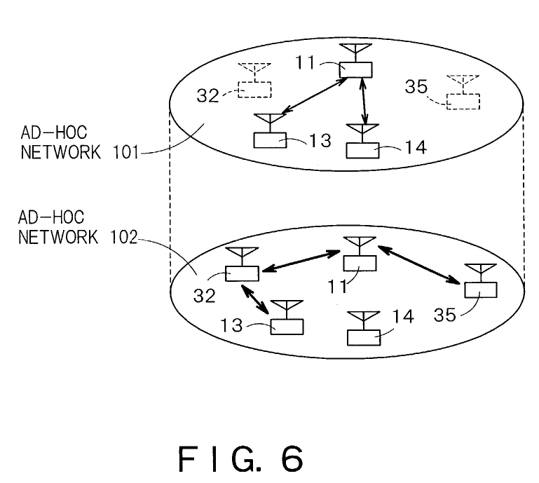

FIG. 6 is a diagram showing a network form of a second embodiment of an ad-hoc network system. The system of FIG. 6 has two ad-hoc networks 101 and 102 with power consumption different from each other. It is assumed that the power consumption of the ad-hoc network 101 is larger than that of the ad-hoc network 102. For example, the ad-hoc network 101 is a network with low power consumption using a frequency hopping system such as a Bluetooth network. The ad-hoc network 102 is a wireless LAN using a direct spread system represented by, for example, IEEE802.11. The terminals communicated with this network have the power consumption higher than the ad-hoc network 101. The ad-hoc networks 101 and 102 are not limited to the Bluetooth system or the IEEE802.11, but may be the wireless LAN systems different from each other.

The wireless terminals 11, 13, 14, 32 and 35 of FIG. 6 can be connected to the multisystems. The wireless terminals 32 and 35 which do not now communicate set the power supply 46 for the ad-hoc network 101 to be off or to be in low power consumption mode. Therefore, it is possible to reduce useless power consumption.

Although the wireless terminals 11, 13, 14, 32 and 35 of FIG. 6 have the same configuration as that of FIG. 3, the operations of the control unit 45 and the power supply 46 are different from those of the first embodiment. The power supply 46 of the present embodiment contains an ampere meter not shown. The control unit 45 instructs the wireless units 41 and 43 to transmit a signal with the same amount of information to the ad-hoc networks 101 and 102. While the wireless units 41 and 43 is transmitting the signals to the ad-hoc networks 101 and 102, the control unit 45 measures the current flowing through the ampere meter. The lower the current flowing through the ampere meter is, the lower the power consumption is. Because of this, the control unit 45 selects the wireless unit with lower power consumption, and performs subsequent communication.

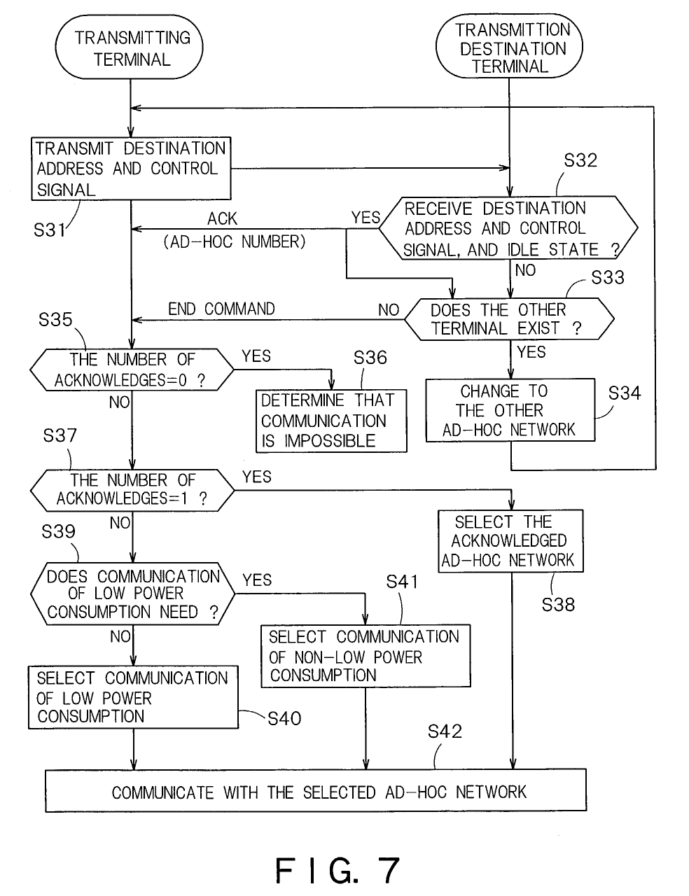

FIG. 7 is a sequence diagram showing processing procedure of a second embodiment of the ad-hoc network system.

The steps S31-S38 of FIG. 7 perform the same processings as steps S11-S18 of FIG. 4. That is, if the number of the ACK signals transmitted from the transmission destination terminal is zero, it is determined that communication is impossible. If “1”, the ad-hoc network which returned the ACK signal is selected to communicate.

On the other hand, the number of the ACK signals is two or more, it is determined whether it is necessary to communicate at low power consumption (step S39). For example, the remaining battery capacity of the transmitting terminal or the transmission destination terminal is checked, and if the remaining battery capacity is low, the ad-hoc network 102 of low power consumption is selected (step S40). If the remaining battery capacity is high, the ad-hoc network 101 of high power consumption is selected (step S41).

For example, it is assumed that the ad-hoc network 101 of FIG. 6 has been selected. Since the wireless terminals 32 and 35 turn off the power supply 46 for the network, it is impossible to transmit the information to the wireless terminals 32 and 35 through the network. In this case, the information is transmitted to the other wireless terminal 11 which can communicate with both of the ad-hoc networks 101 and 102, and the information is transmitted from the wireless terminal 11 to the wireless terminals 32 and 35 through the ad-hoc network 102.

Thus, according to the second embodiment, a plurality of ad-hoc networks are selectively used for power consumption. Because of this, it is possible to reduce power consumption, and it is possible to transmit the information through the other ad-hoc network for the wireless terminal which turns off the power supply 46 for a certain ad-hoc network.

For example, when the ad-hoc system 101 of high-speed and high power consumption and the ad-hoc system 102 of low-speed and low power consumption exist together, it is possible to distinguish the ad-hoc systems if necessary. For example, the ad-hoc system 101 is used for the information which has to communicate at high-speed, and the ad-hoc system 102 is used for the information which may be communicated at low speed.

(Third Embodiment)

One of features of a third embodiment lies in that a plurality of ad-hoc network are selectively used for security levels.

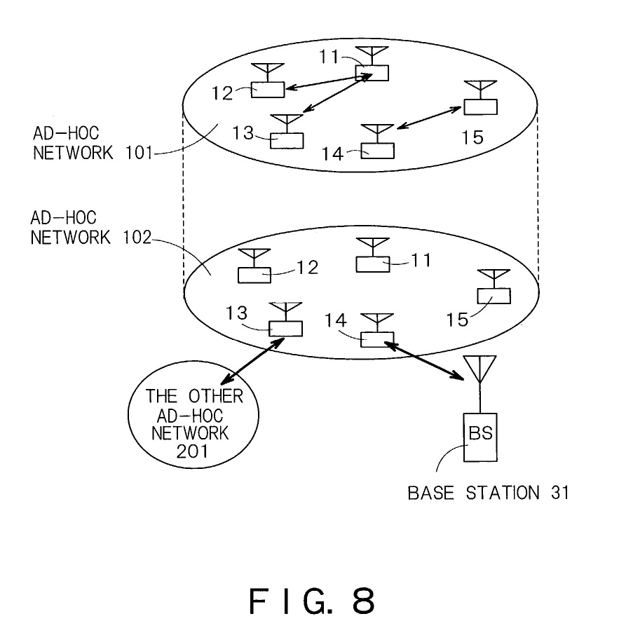

FIG. 8 is a diagram showing a network form of the third embodiment of an ad-hoc network system. The system of FIG. 8 has two ad-hoc networks 101 and 102 with security levels different each other. It is assumed that the security level of the ad-hoc network 101 is higher than that of the ad-hoc network 102.

The ad-hoc network 101 is used when the wireless terminal belonging to the same network communicates only in the network, and the ad-hoc network 102 is used when communicating with the base station 31 or the other ad-hoc network 201.

On the contrary, if it is assumed that only the terminals reliable to each other communicate, data communication with low security level may be performed by using the ad-hoc network 101 which is not connected to the other network. When communicating with the base station 31 or the other ad-hoc network 201, data communication with high security level may be performed by using the ad-hoc network 102.

Furthermore, when communicating between the wireless terminals, when a circumstance for heightening the security level occurs, the ad-hoc network with high security level may be arbitrarily selected.

As a method of heightening the security level, for example, a method of using data which excels in security performance or encryption data is supposed.

The wireless terminals 11-15 belonging to the ad-hoc network 101 of FIG. 8 can be connected to the multisystem, and the internal configuration is the same as that of FIG. 3. Operation of the control unit 45 is different from those of the first and second embodiments.

The control unit 45 in the wireless terminals 11-15 of the third embodiment instructs the wireless units 41 and 43 to check the security level of the ad-hoc networks 101 and 102. The wireless units 41 and 43 check whether or not the other ad-hoc network 201 or the base station 31 is connected to the ad-hoc networks 101 and 102. The control unit 45 determines that the security level of the ad-hoc network 101 to which nothing is connected is higher than that of the ad-hoc network 102 to which the other ad-hoc network 201 or the base station 31 is connected. When the information to be transmitted requires high security, the information is transmitted by using the ad-hoc network 101. When the information does not require high security, the information is transmitted by using the ad-hoc network 102.

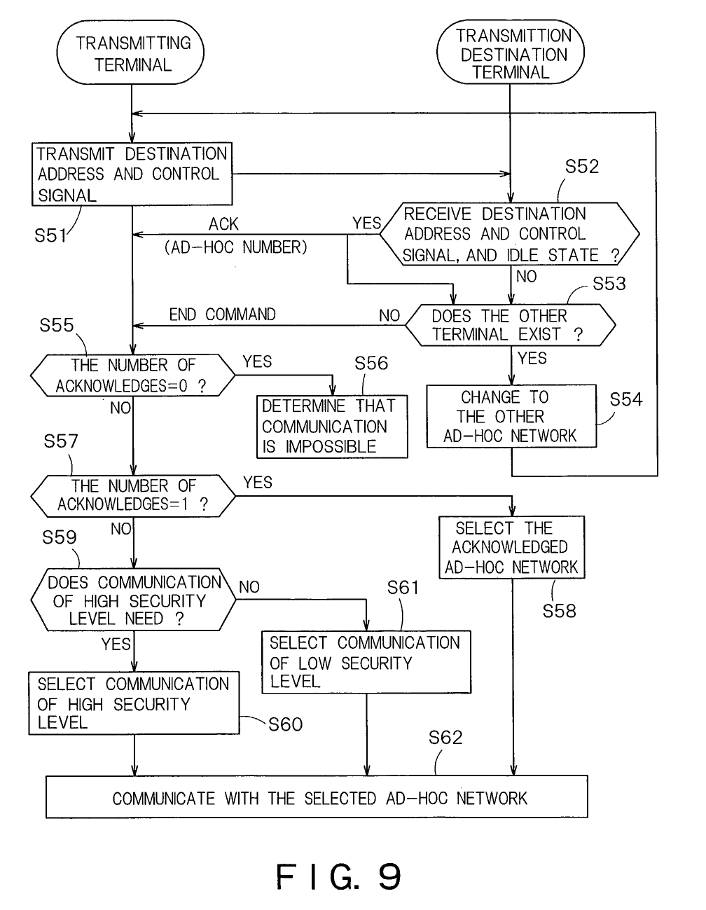

FIG. 9 is a sequence diagram showing processing procedure of the third embodiment of the ad-hoc network system.

Steps S51-S58 of FIG. 9 perform the same processings as step S11-S18 of FIG. 5. That is, if the number of the ACK signals from the transmission destination terminal is zero, it is determined that communication is impossible. If “1”, the ad-hoc network which returned the ACK signal is selected to communicate.

If the number of the ad-hoc network which returned the ACK signal is two or more, it is determined whether or not communication with high security level is necessary (step S59). If such a communication is necessary, the ad-hoc network with high security level is selected (step S60). If such a communication is unnecessary, the ad-hoc network with low security level is selected (step S61).

Thus, according to the third embodiment, since a plurality of ad-hoc networks are selectively used for the security levels, it is possible to prevent leakage of important data.

(Fourth Embodiment)

One of features of a fourth embodiment lies in that a plurality of ad-hoc networks are selectively used for interference tolerance properties.

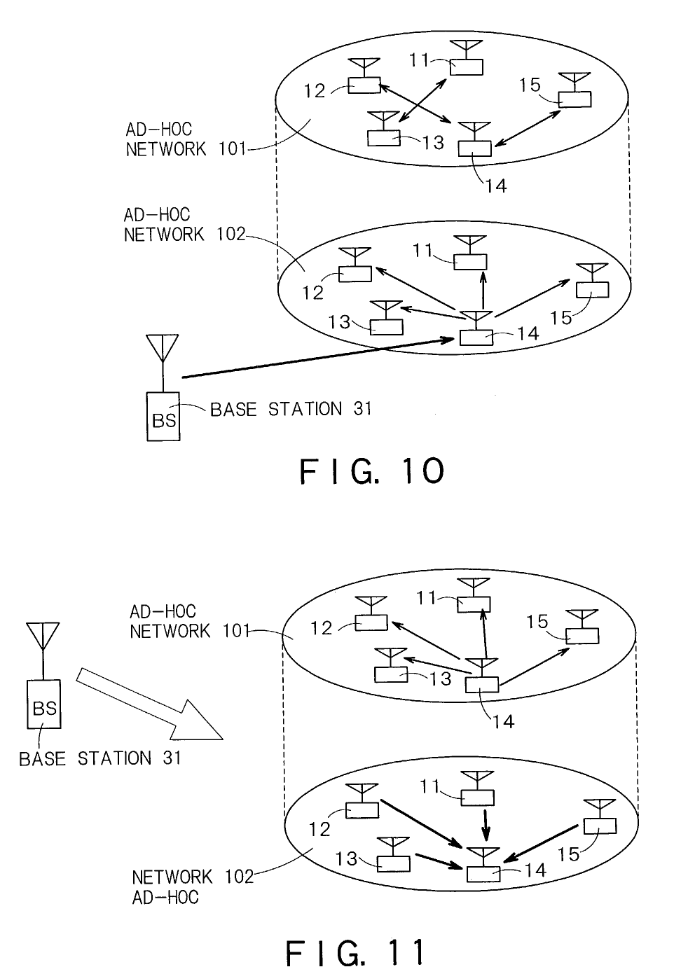

FIG. 10 is a diagram showing a network form of the fourth embodiment of the ad-hoc network system. The system of FIG. 10 has two ad-hoc networks 101 and 102 with modulation systems and frequencies different from each other, and the wireless terminal 14 receives the information from the base station 31 of a central control network such as a cellular network.

Even if either of ad-hoc network 101 or 102 is used, when the wireless terminal 14 cannot normally receive the signal from the base station 31 due to fading, the wireless terminal 14 transmits the control signal which instructs the other wireless terminals 11-13 and 15 to cooperate to reception.

Each of the wireless terminals 11-13 and 15 which has received the control signal receives a fragment of the signal including the large amount of information such as moving image and data from the base station 31 through the ad-hoc network 102 by cooperating to each other, as shown in FIG. 11, and transmits the received fragment to the wireless terminal 14. The wireless terminal 14 combines the fragments of these information, and transmits the combined information to the respective wireless terminals which want transmission, through the ad-hoc network with better interference tolerance property at the time.

Since the wireless terminals 11-13 and 15 receive the fragments of the information in units of a packet, the wireless terminal 14 combines the packets with reference to header information of the packets.

As the other example, when the wireless terminal communicates with the base station and the other wireless terminal, the ad-hoc network with better interference tolerance at the time is selected to communicate. For example, when the ad-hoc network 101 is a Bluetooth network, and the ad-hoc network 102 is a wireless LAN using a direct spread system represented by IEEE802.11, if the wireless LAN is better in interference tolerance property of the wireless terminal than the Bluetooth network, the wireless LAN is used to communicate.

Although internal configuration of the wireless terminal 14 is the same as that of FIG. 3, the operation of the control unit 45 is different from the first to third embodiments.

When the control unit 45 of the wireless terminal 14 determines that the wireless unit 41 cannot normally receive the signal, the control unit 45 transmits a signal which requests reception cooperation to the other wireless terminals. When the signal cooperatively received by the other wireless terminals is received by the wireless unit 43, the processing for combining the reception signal with reference to header information of the packets is performed.

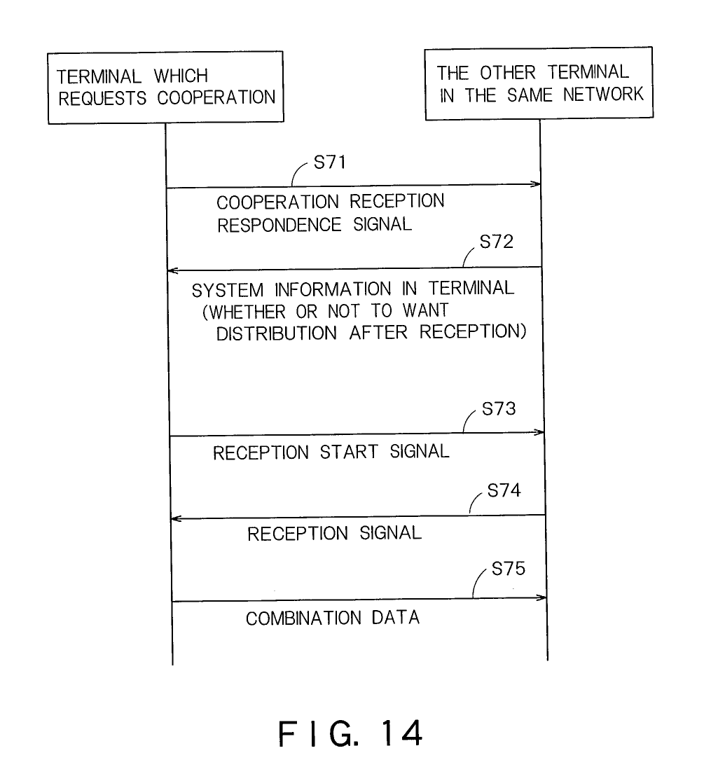

FIG. 14 is a sequence diagram showing processing procedure in which the fragments of the information cooperatively received by the wireless terminals are combined and then distributed to the wireless base stations. First of all, the wireless terminal 14 which requests cooperation transmits cooperation request information to the other wireless terminals 11-13 and 15 in the network by including in the control information (step S71).

The wireless terminals 11-13 and 15 which received the control signal send back a response signal indicating whether or not to respond to the cooperation request and a signal indicating whether or not to desire distribution of information from the base station 31 received by the wireless terminal which requested cooperation (step S72).

Subsequently, the wireless terminal 14 which requested cooperation transmits a reception start signal (step S73). Therefore, the wireless terminals 11-13 and 15 receive the fragments of the information from the base station 31. FIG. 11 shows an example in which all the wireless terminals 11-13 and 15 in the ad-hoc network respond to cooperation request.

The wireless terminals 11-13 and 15 which respond to the cooperation request transmit the fragments of the received information to the wireless terminal 14 which requested the cooperation, as shown in FIG. 11 (step S74). The wireless terminal 14 which requested the cooperation combines the fragments of the information, and distributes the combined information to the wireless terminals 11-13 and 15 which desires the distribution, via the same or other ad-hoc network (step S75).

When the information is distributed, the ad-hoc network to be used is decided by taking into consideration the simultaneity of distribution and reception, and interference tolerance property of the networks during distribution period. For example, when distribution and reception of information are almost simultaneously performed, different ad-hoc networks are used between distribution and reception. When reception is performed after distribution of information, the ad-hoc network which excels in interference tolerance property is used.

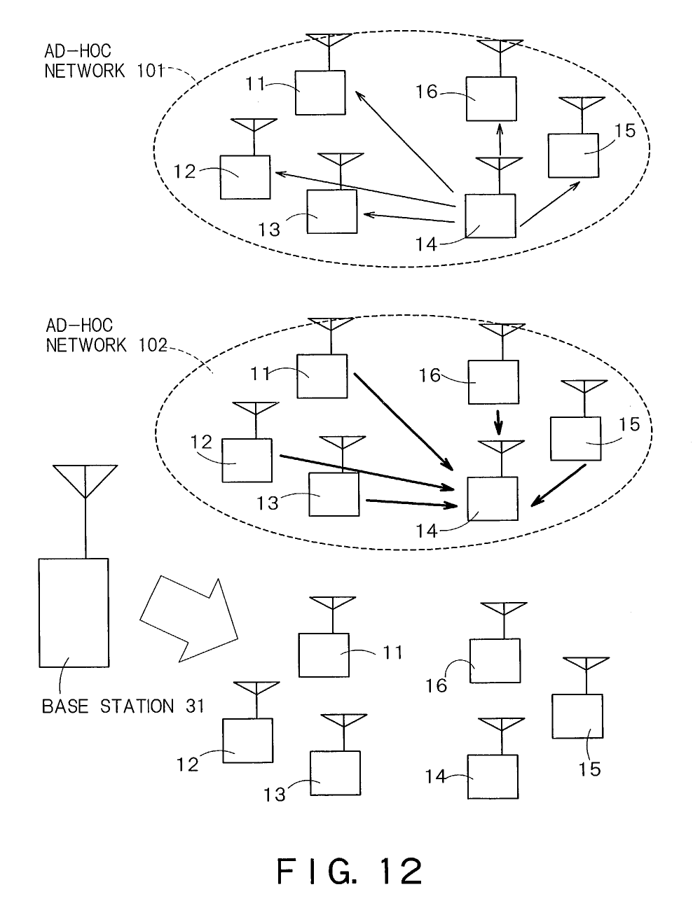

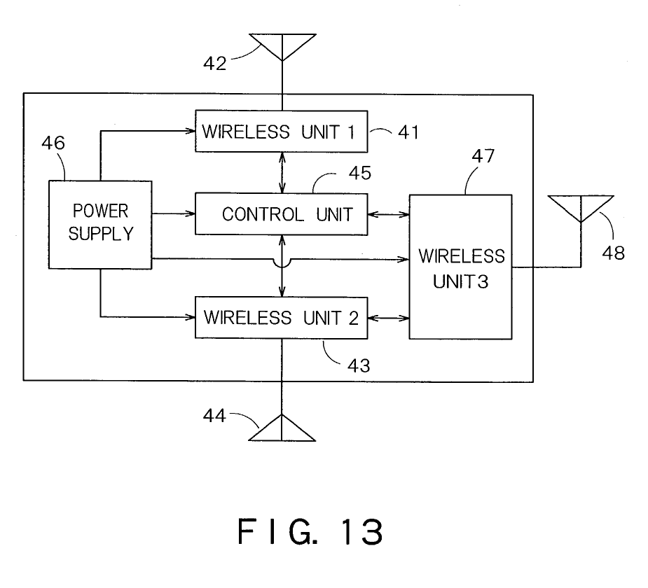

As shown in FIG. 12, the terminal used for the system of the present embodiment may be constituted of terminals capable of connecting to two ad-hoc networks 101 and 102 with modulation systems and frequencies different from each other, and a central control network such as a cellular network. FIG. 13 is a block diagram showing one example of such a terminal.

In FIG. 13, reference number 41 is a wireless unit for connecting to the ad-hoc network 101, reference number 42 is an antenna corresponding to the ad-hoc network 101, reference number 43 is a wireless unit for connecting to the ad-hoc network 102, reference number 44 is an antenna corresponding to the ad-hoc network 102, and reference number 45 is a control unit. The wireless unit 3 is a wireless unit for connecting to the base station 31, and reference number 48 is an antenna corresponding to the wireless unit 3.

The control unit 45 transmits the signal which requests reception cooperation to the other wireless terminals through the wireless units 41 and 43 when determined that the wireless terminal 47 cannot normally receive the signal. Since the data amount of the signal is small, communication may be performed by using the wireless unit 41 through the ad-hoc network 101 at low speed. The signal cooperatively received by the other wireless terminals may be transmitted and received through the ad-hoc network 102 at high speed. Therefore, it is possible to avoid data congestion. In FIG. 13, the wireless terminal 14 performs the processings which combine the signal from the other terminals which is received by the other wireless terminals, with reference to header information of the packet.

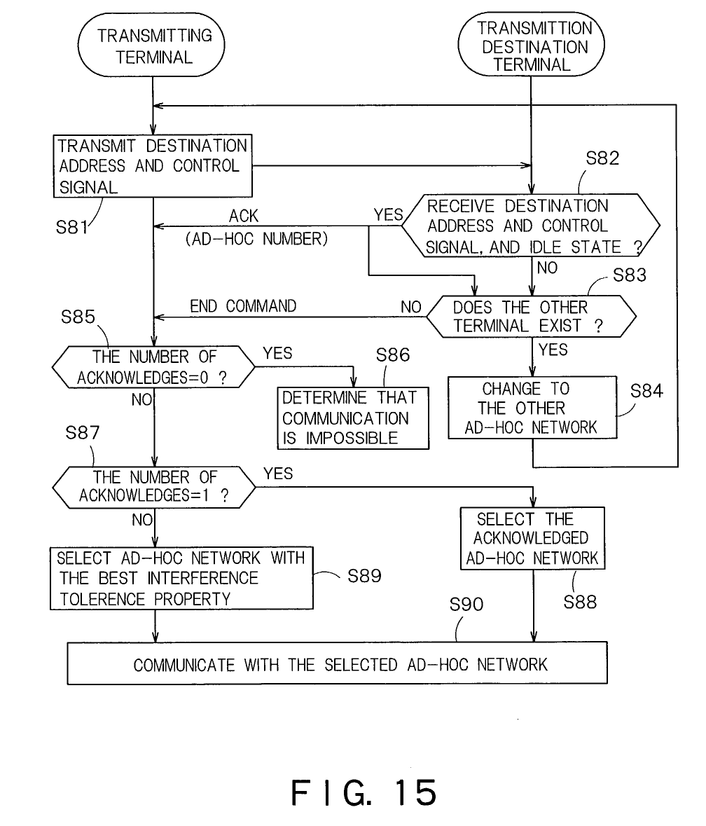

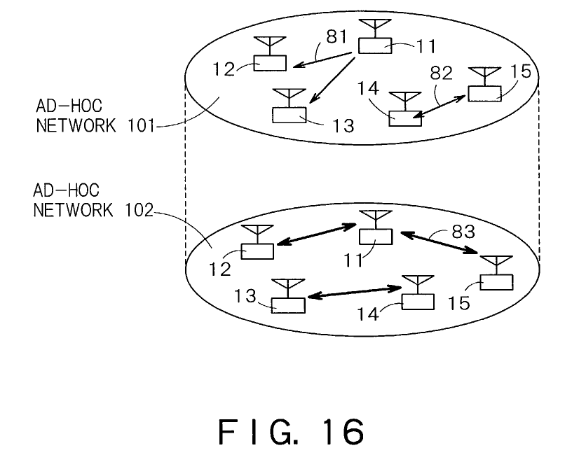

FIG. 15 is a sequence diagram showing processing procedure in the case of selectively using a plurality of ad-hoc network according to interference tolerance properties.

Steps S81-S88 of FIG. 15 perform the same processings as steps S11-S18 of FIG. 4. That is, if the number of the ACK signals from the transmission destination terminal is zero, it is determined that communication is impossible. If “1”, the ad-hoc network which returned the ACK signal is selected to communicate.

If the number of the ad-hoc networks which returned the ACK signal is two or more, the network with the best interference tolerance properties at that time is selected (step S89).

Thus, according to the fourth embodiment, when the information from the base station is received, a plurality of wireless terminals in the same ad-hoc network cooperate to each other to receive fragments of the information, and combine the information after receiving the information. Because of this, even if the information from the base station is a large amount of information, it is possible to receive the information at short time.

Furthermore, when the combined information is distributed, the distributed ad-hoc network is determined by taking into consideration the simultaneity of reception and distribution of information, and the interference tolerance property of the ad-hoc network during distribution period. Because of this, it is possible to distribute the information to the transmission destinations without losing the information.

(Fifth embodiment)

One of features of a fifth embodiment lies in that a plurality of ad-hoc networks are selectively used for the transmitting and receiving information.

FIG. 16 is a diagram showing a network form of an ad-hoc network system. The system of FIG. 16 has an ad-hoc network 101 for emphasizing immediacy such as phone call and an ad-hoc network 102 which does not emphasize immediacy such as data.

Here, as the transmitting and receiving information, for example, it is assumed that there are the control signal, the phone call and data. Since the phone call and the control signal request immediacy, these are transmitted through the ad-hoc network 101. Data such as character information and still image to which immediacy is not requested is transmitted through the ad-hoc network 102. It is desirable that moving image is transmitted through the ad-hoc network 101 which requests immediacy.

In the example of FIG. 16, the wireless terminal 11 transmits the control signal to the wireless terminals 12 and 13 through the ad-hoc network 101, and the wireless terminals 14 and 15 perform phone call through the ad-hoc network 101 to each other. The wireless terminals 11 and 12 and the wireless terminals 13 and 14 perform data communication to each other through the ad-hoc network 102.

The wireless terminals 11-15 belonging to the ad-hoc network 101 of FIG. 16 can be connected to the multisystem, and the internal configuration thereof is the same as that of FIG. 3. The operation of the control unit 45 is different from the first to fourth embodiments.

The control unit 45 in the wireless terminals 11-15 of the fifth embodiment determines whether or not the information to be transmitted requests the immediacy, and the wireless unit to transmit the information is determined according to the result of the determination.

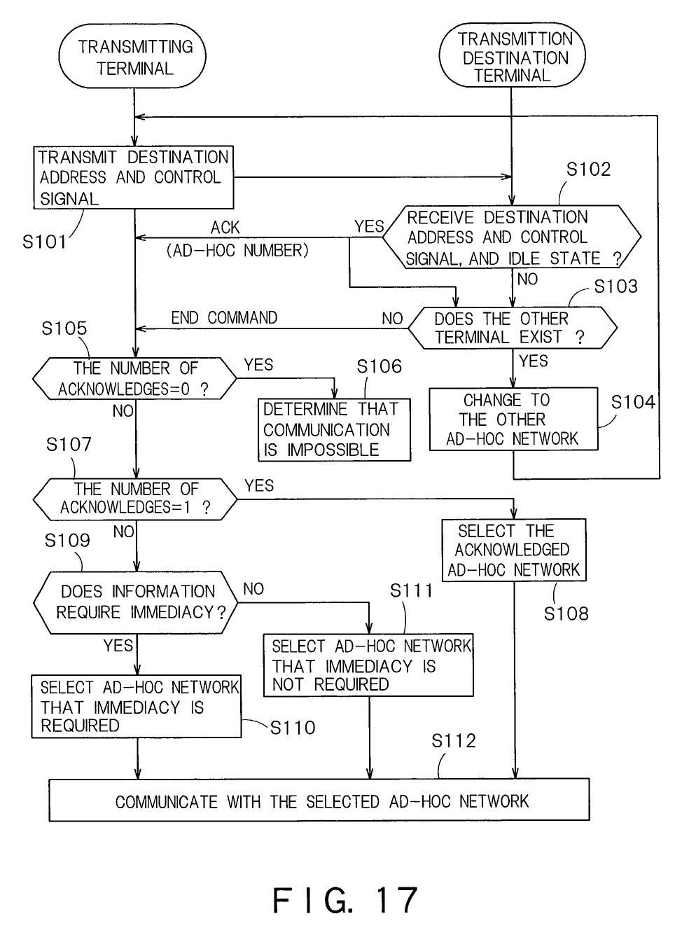

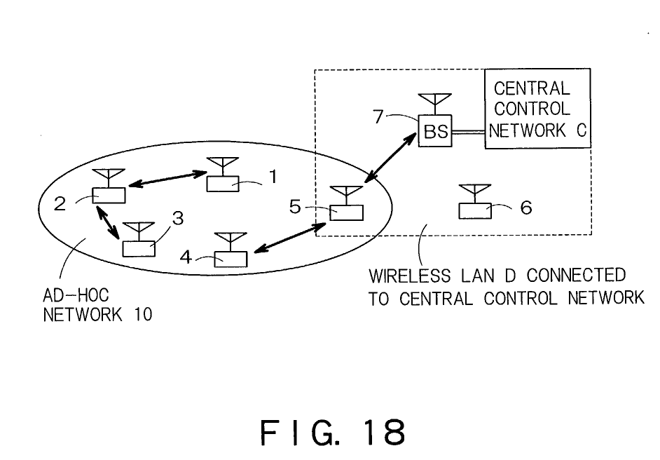

FIG. 17 is a sequence diagram showing processing procedure of a fifth embodiment of an ad-hoc network system.

Steps S101-S108 of FIG. 17 perform the same processings as step S11-S18 of FIG. 5. That is, if the number of the ACK signals from the transmission destination terminal is zero, it is determined that communication is impossible, and if “1”, the ad-hoc network which returned the ACK signal is selected to communicate.

If the number of the ad-hoc network which requested the ACK signals is two or more, it is determined whether or not the transmitting and receiving information require immediacy (step S109). In the case of the information in which immediacy is required (for example, the case of transmitting the phone call and the control signal), the ad-hoc network 101 is selected (step S110). In the case of the information in which immediacy is not required (for example, the case of transmitting data), the ad-hoc network 102 is selected (step S111).

In FIG. 17, the example in which the ad-hoc networks 101 and 102 are selectively used for whether or not the transmitting and receiving information requires immediacy has been shown. When the wireless LAN system capable of transmitting sound information at high sound quality and the other wireless LAN suitable for high speed data transmission exist together, one may be allocated to the ad-hoc network 101, and another may be allocated to the ad-hoc network 102.

Thus, according to the fifth embodiment, a plurality of ad-hoc networks are selectively used for the types of the transmitting and receiving information. Because of this, it is possible to select the ad-hoc network most suitable for the kinds of the transmitting and receiving information, thereby effectively using resources.

In the above first to fifth embodiments, an example in which two ad-hoc networks are provided has been described. Three or more ad-hoc networks may be provided. Furthermore, the present invention is applicable that a parent terminal and a child terminal distinguished to each other are included in a plurality of wireless terminals belonging to the ad-hoc networks.

What is claimed is:

1. An autonomous distributed wireless network system in which a plurality of wireless terminals communicate with each other, comprising:
a plurality of autonomous distributed wireless networks each having a different communication form, and being constituted of a plurality of wireless terminals,
wherein each of said plurality of wireless terminals has a network selector which allocates said plurality of autonomous distributed wireless networks to communicate different categories of information with different autonomous distributed wireless networks.

2. The autonomous distributed wireless network system according to claim 1,
wherein said categories include at least one of communication quality, power consumption, security level, interference tolerance property and the kinds of the transmitting and receiving information.

3. The autonomous distributed wireless network system according to claim 1,
wherein said communication form is communication speed; and
said network selector selects the autonomous distributed wireless network with a prescribed communication speed based on a state of a communication path between the transmitting and receiving wireless terminals.

4. The autonomous distributed wireless network system according to claim 3,
wherein said network selector selects the autonomous distributed wireless network with a higher communication speed, as a distance between the transmitting and receiving wireless terminals becomes shorter, or a reception signal strength becomes stronger.

5. The autonomous distributed wireless network system according to claim 3,
wherein said network selector selects the autonomous distributed wireless network with a higher communication speed when the transmitting and receiving information requires immediacy, as compared with the case where immediacy is not required.

6. The autonomous distributed wireless network system according to claim 1,
wherein said communication form is a power consumption; and
said network selector selects one of said plurality of autonomous distributed wireless networks, taking into consideration the power consumption of said wireless terminal to transmit and receive information.

7. The autonomous distributed wireless network system according to claim 6,
wherein said network selector selects the autonomous distributed wireless network system with a less power consumption, as the remaining capacity of a battery of said wireless terminal becomes lower.

8. The autonomous distributed wireless network system according to claim 7,
wherein said network selector selects that said autonomous distributed wireless network with the lowest power consumption.

9. The autonomous distributed wireless network system according to claim 6,
wherein said network selector determines that the autonomous distributed wireless network in which power consumption of the wireless terminal to transmit and receive information is zero is in an off state, and selects one of the other autonomous distributed wireless networks.

10. The autonomous distributed wireless network system according to claim 1,
wherein said communication form is security level; and
said network selector selects one of said plurality of autonomous distributed wireless networks based on at least one of whether or not the wireless terminals of communication destination belong to a same autonomous distributed wireless network, and contents of the transmitting and receiving information.

11. The autonomous distributed wireless network system according to claim 10,
wherein said network selector selects different autonomous distributed wireless networks in the case where the communication destination belongs to the same autonomous distributed wireless network and in the case where the communication destination does not belong to the same autonomous distributed wireless network.

12. The autonomous distributed wireless network system according to claim 1,
wherein said communication form is interference tolerance property; and
said network selector selects an autonomous distributed wireless network with a better interference tolerance property.

13. The autonomous distributed wireless network system according to claim 1,
wherein at least one of said plurality of autonomous distributed wireless networks can communicate with abase station; and
at least one of said plurality of wireless terminals includes:
an information combination unit which combines information from said base station, said information being received by a plurality of wireless terminals belonging to the autonomous distributed wireless network capable of communicating with said base station; and
an information transmission unit which transmits the information to the other wireless terminals which request the combined information.

14. The autonomous distributed wireless network system according to claim 13,
wherein said communication form is interference tolerance property; and
said network selector transmits the information to the other wireless terminal, which requests the combined information combined by said information combination unit, through the autonomous distributed wireless network with a better interference tolerance property.

15. A method of autonomous distributed wireless network communication in which a plurality of wireless terminals communicate with each other, comprising:
forming a plurality of autonomous distributed wireless networks each having a different communication form, and being constituted of a plurality of wireless terminals; and
communicating different categories of information by using different autonomous distributed wireless networks.

16. The method of autonomous distributed wireless network communication according to claim 15,
wherein said categories include at least one of communication quality, power consumption, security level, interference tolerance property and the kinds of the transmitting and receiving information.

17. The method of autonomous distributed wireless network communication according to claim 15,
said communication form is at least one of communication speed, power consumption, security level and interference tolerance property.

18. A wireless terminal which constitutes an autonomous distributed wireless network system, comprising:
a network formulating unit which formulates a plurality of autonomous distributed wireless networks each having a different communication form; and
a network selector which allocates said plurality of autonomous distributed wireless network to communicate different categories of information by using different autonomous distributed wireless networks.

19. The wireless terminal according to claim 18, comprising:
wherein said categories include at least one of communication quality, power consumption, security level, interference tolerance property and the kinds of the transmitting and receiving information.

20. The wireless terminal according to claim 18, comprising:
said communication form is at least one of communication speed, power consumption, security level and interference tolerance property.
